(19) United States
(12) Patent Application Publication
(10) Pub. No.: US 2007/0151298 A1
(43) Pub. Date: Jul. 5, 2007

(54) Vapor axial deposition apparatus and method for fabricating soot preform using the same

(75) Inventors: Jin-Haing Kim, Seoul (KR); Ho-Jin Lee, Suwon-si (KR); Mun-Hyun Do, Gyeongsangbuk-do (KR); Jae-Hyeon Seong, Kimcheon-si (KR); Yun-Ho Kim, Dong-gu (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/489,959

(22) Filed: Jul. 20, 2006

(30) Foreign Application Priority Data
Jan. 3, 2006 (KR) 2006-560

(51) Int. Cl. C03B 37/07; C03B 37/018; F27B 1/26

(52) U.S. Cl. 65/384; 65/414; 65/488; 65/531

(57) ABSTRACT

Vapor Axial Deposition (VAD) apparatus and method is provided. The VAD apparatus includes a first torch, a second torch, a thermometer, a controller, and a moving device. The first torch grows a core by depositing a soot at an end of a soot preform arranged on an axis. The second torch grows a clad by depositing a soot on the face of the core. The thermometer detects the temperature of the end of the soot preform along the axis and the temperature of an other/lower portion of the core. The controller calculates a difference between a temperature (T1) of the end of the soot preform and a temperature (T4) of a lower portion of the core and controls the movement of the soot preform according to the difference. The moving device moves the soot preform along the axis according to the instruction of the controller.

### CLAIM OF PRIORITY

This application claims priority under 35 U.S.C. §119 to an application entitled “Vapor Axial Deposition (VAD) Apparatus and Method for Fabricating Soot Preform Using the Same,” filed in the Korean Intellectual Property Office on Jan. 3, 2006 and assigned Serial No. 2006-560, the contents of which are incorporated herein by reference.

### BACKGROUND OF THE INVENTION

1. Field of the Invention

The present invention generally relates to an apparatus and method for fabricating an optical fiber preform, and in particular, to a Vapor Axial Deposition (VAD) apparatus and method.

2. Description of the Related Art

FIG. 1 illustrates a conventional apparatus 100 for fabricating an optical fiber preform. A Vapor Axial Deposition (VAD) method forms a soot preform 120 by depositing soot in a starting rod made of glass using a first torch 140 and a second torch 150 and growing a core 122 and a clad 124 in the direction of a vertical axis 110. Next, sintering is performed on the soot preform 120, thus fabricating the optical fiber preform.

A laser 131 and a light receiving device 132 are arranged opposite to each other with respect to the core 122. The light receiving device 132 detects the magnitude of a light generated from the laser 131. The magnitude of the generated light is reduced because the light is occluded by the soot preform 120. This light reduction is due to the growth of the soot preform 120 through the deposition of the soot. The magnitude of the light detected by the light receiving device 132 is provided to a separate control means. The movement of the soot preform 120 is determined by a change in the magnitude of the light.

U.S. Pat. No. 6,834,516 issued to Donald P. Jablonowski et al. and entitled “Manufacture of Optical Fiber Preforms Using Modified VAD” discloses measuring the tip temperature of a soot preform using an optical pyrometer and controlling the flow of hydrogen gas provided to a core torch. Using this method a soot preform is manufactured that has a uniform composition.

However, a VAD apparatus that uses a laser and a light receiving device has a complex structure and it is difficult to control.

In the foregoing VAD method, a measurement point for the optical pyrometer is moved, since the soot preform must rotate at a fixed speed. As a result, it is not easy to accurately measure temperature. Accordingly, the foregoing VAD method has difficulty in accurately measuring the temperature of the tip of the soot preform and controlling the tip of the soot preform. This, in turn, results in degradation in mass production and reliability.

### SUMMARY OF THE INVENTION

It is, therefore, an object of the present invention to provide a Vapor Axial Deposition (VAD) apparatus and method that improves the quality of a soot preform based on the overall temperature distribution of the end of the soot preform. In addition, the VAD apparatus and method has a high mass production rate and high reliability.

According of the principles of the present invention, a Vapor Axial Deposition (VAD) apparatus is provided. The VAD apparatus includes a first torch, a second torch, a thermometer, a controller, and a moving device. The first torch grows a core by depositing a soot at an end of a soot preform arranged on an axis. The second torch grows a clad by depositing a soot on the face of the core. The thermometer detects the temperature of the end of the soot preform along the axis and the temperature of an other/lower portion of the core. The controller calculates a difference between a temperature (T1) of the end of the soot preform and a temperature (T4) of a lower portion of the core and controls the movement of the soot preform according to the difference. The moving device moves the soot preform along the axis according to the instruction of the controller.

In addition, according to the principles of the present invention, a VAD method is provided for depositing a soot on a core in a soot preform arranged on an axis using a first torch and a second torch. The VAD method includes the steps of detecting a temperature (T1) of an end of the soot preform along the axis and a temperature (T4) of an other/lower portion of the core, calculating a difference between T1 and T4, and moving the soot preform along the axis to reduce the difference to a predetermined temperature or less.

### BRIEF DESCRIPTION OF THE DRAWINGS

The present invention will become more apparent from the following detailed description when taken in conjunction with the accompanying drawings in which:

FIG. 1 illustrates a conventional Vapor Axial Deposition (VAD) apparatus;

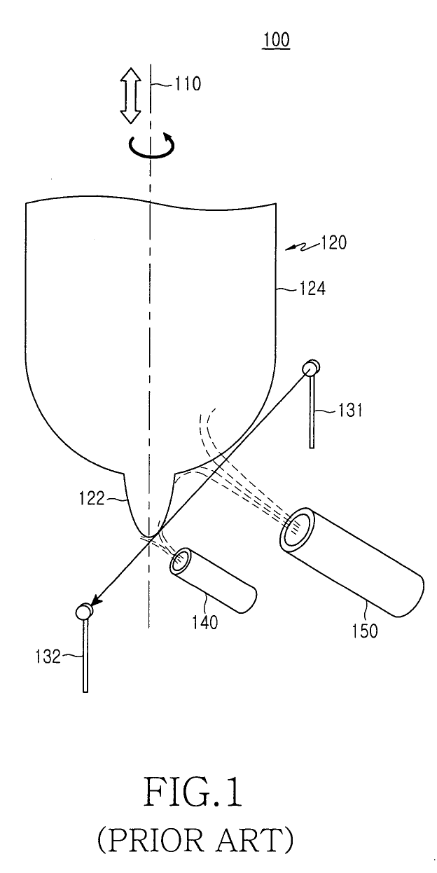

FIG. 2 illustrates a VAD apparatus according to a preferred embodiment of the present invention;

FIG. 3 illustrates a thermal image detected by a thermometer illustrated in FIG. 2; and

FIG. 4 is a graph illustrating the temperature distribution of an end of a soot preform along a vertical axis illustrated in FIG. 2.

### DETAILED DESCRIPTION OF THE INVENTION

An embodiment of the present invention will now be described in detail with reference to the annexed drawings. For the purposes of clarity and simplicity, a detailed description of known functions and configurations incorporated herein will be omitted to avoid making the subject matter of the present invention unclear.

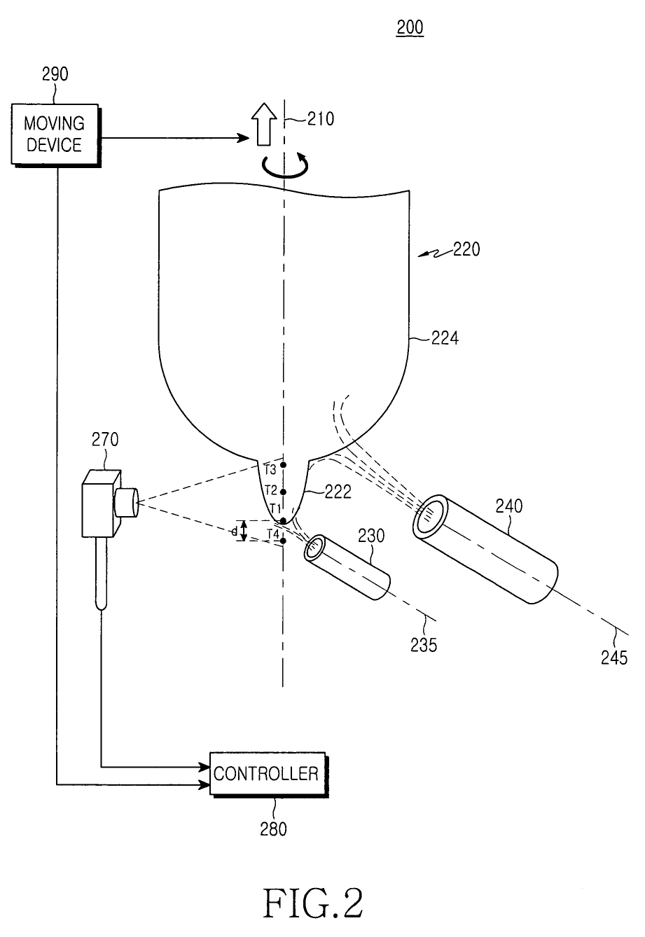

FIG. 2 illustrates a Vapor Axial Deposition (VAD) apparatus 200 according to a preferred embodiment of the present invention. Referring to FIG. 2, the VAD apparatus 200 includes a first torch 230 and a second torch 240 for forming a soot, a thermometer 270 for detecting the temperature distribution of an end of a soot preform 220 along a vertical axis 210, a moving device 290 for moving the soot preform 220 along the vertical axis 210, and a controller 280 for controlling the moving device 290.

The soot preform 220 is arranged on the vertical axis 210. The soot preform 220 includes a starting rod made of glass, which provides a growth base, and a core 222 and a clad 224, which is formed by depositing the soot at an end of the starting rod. The core 222 has a relatively high refractive index. The clad 224 surrounding the core 222 has a relatively low refractive index. At the beginning of soot deposition, a ball is formed by depositing the soot at an end of the starting rod using the second torch 240. Once the size of the ball reaches a predetermined size, the core 222 and the clad 224 are simultaneously formed on the ball using the first torch 230 and the second torch 240. When the core 222 and the clad 224 are directly grown at an end of the starting rod without the ball being formed, the starting rod and the soot preform 220 may be separated. If the starting rod and the soot preform 220 are not separated a crack may be generated in the soot preform 220 due to the weight of the soot preform 220. During soot deposition, the soot preform 220 rotates and moves upwardly at a preset speed. By rotating with respect to the vertical axis 210, the soot preform 220 can have rotational symmetry. By upwardly moving along the vertical axis 210, the soot preform 220 can be continuously grown downwardly along the vertical axis 210. Hereinafter, the growing direction of the soot preform 220 with respect to the vertical axis 210 will be assumed to be a downward direction and the inverse direction to the growing direction will be assumed to be an upward direction.

A central axis 235 of the first torch 230 is inclined with respect to the vertical axis 210 at an acute angle. A flame is thrown to the end of the soot preform 220 to grow the core 222 downwardly from the end of the soot preform 220. The torch 230 provides a glass raw material such as SiCl₄ and GeCl₄ and a fuel material in which hydrogen and oxygen are mixed. The soot is generated by the hydrolysis of the glass raw material in the thrown flame. The generated soot is deposited in the soot preform 220. The hydrolysis formulas of oxides composing the soot, i.e., SiO₂ and GeO₂ are as follows.

SiCl₄+2H₂O→SiO₂+4HCl (1)

GeCl₄+2H₂O→GeO₂+4HCl (2)

The second torch 240 is upwardly separated from the first torch 230. The second torch's central axis 245 is inclined with respect to the vertical axis 210 at an acute angle. The second torch 240 grows the clad 224 on the circumferential face of the core 222 by throwing a flame to the circumferential face of the core 222. The second torch 240 provides a glass raw material such as SiCl₄ and GeCl₄ and a fuel material in which hydrogen and oxygen are mixed. The soot is generated by the hydrolysis of the glass raw material in the thrown flame. The generated soot is deposited in the soot preform 220.

By controlling the flow or type of glass raw material provided in the first torch 230, such that it is different from that of the glass raw material provided in the second torch 240, the core 222 can have a higher refractive index than the clad 224. For illustrative purposes only, GeO₂ or P₂O₅ increases a refractive index and F or B₂O₃ reduces the refractive index.

Optical characteristics (for example, dispersion and macro bend loss) of an optical fiber acquired from the soot preform 220 are affected by the tip temperature of the soot preform 220 and the surface temperature of a portion in which soot deposition is performed, i.e., the end of the soot preform 220.

The thermometer 270 is arranged at a side of the soot preform 220. The thermometer 270 detects the thermal image of the end of the soot preform 220 along the vertical axis 210 and the temperature of a point that is downwardly separated from the core 222. The thermometer 270 outputs the detected thermal image and temperature to the controller 280. At this time, the thermal image includes temperature distribution information of the end of the soot preform 220 along the vertical axis 210. In addition, the end of the soot preform 220 includes the portion in which soot deposition is performed (i.e., an exposed portion of the core 222 at the end of the soot preform 220 and a boundary portion between the core 222 and the clad 224 along the vertical axis 210). A thermal imager such as FTI 6 from LAND instruments international Ltd. may be used as the thermometer 270.

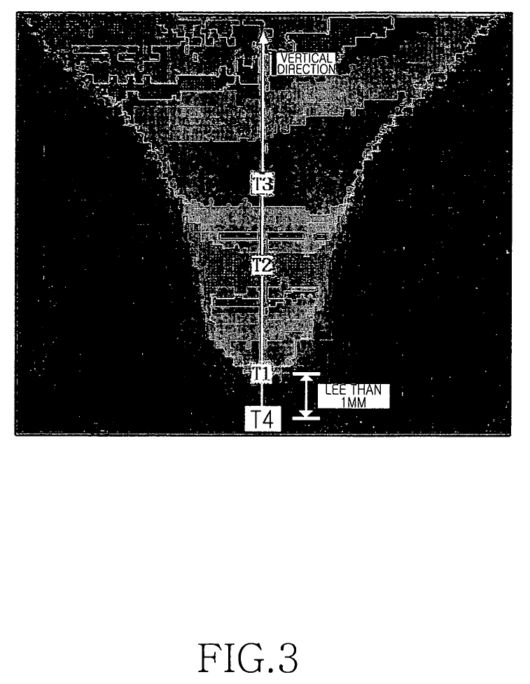

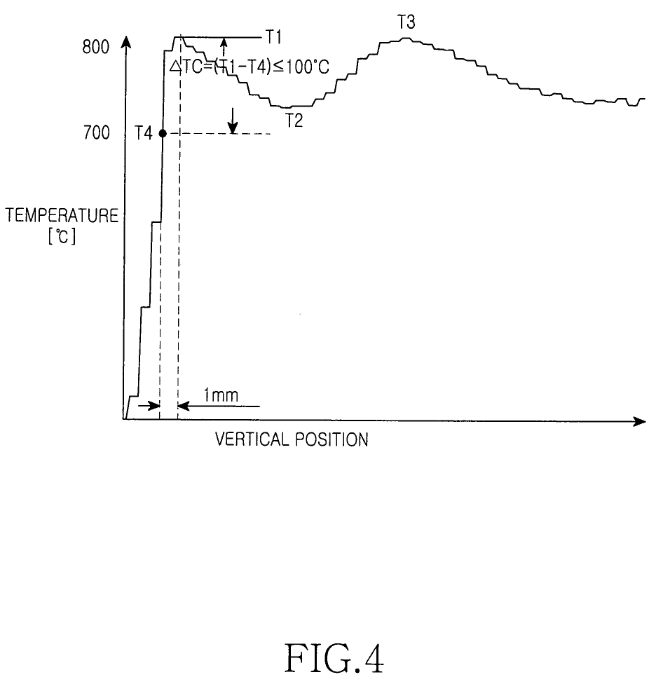

FIG. 3 illustrates a thermal image detected by the thermometer 270 and the temperature of a lower portion of the core 222. FIG. 4 is a graph illustrating the temperature distribution of the end of the soot preform 220 along the vertical axis 210.

In FIG. 3, an upward direction (indicated by an arrow) along the vertical axis 210, a first maximum temperature T1, a minimum temperature T2, a second maximum temperature T3, and a temperature T4 of a lower portion of the core 222 are shown. In FIG. 4, a vertical axis indicates temperature and a horizontal axis indicates a position on the vertical axis 210, i.e., a vertical position.

As shown in FIGS. 3 and 4, the first maximum temperature T1 appears at the tip of the soot preform 220. The second maximum temperature T3 appears at the boundary portion between the core 222 and the clad 224 along the vertical axis 210. The minimum temperature T2 appears in an intermediate position between the tip of the soot preform 220 and the boundary portion. This is because the flame concentrated point of the first torch 230 (i.e., a point on the surface of the soot preform 220 in which the flame of the first torch 230 is concentrated) is at the tip of the soot preform 220 and the flame concentrated point of the second torch 240 is at the boundary portion.

The first maximum temperature T1 is controlled by controlling the flow of the fuel material provided in the first torch 230. The second maximum temperature T3 is controlled by controlling the flow of the fuel material provided in the second torch 240.

With soot deposition, the core 222 is downwardly grown at around T4. Thus, T4 gradually increases. The controller 280 calculates a difference between T1 and T4 input from the thermometer 270. When the difference between T1 and T4 reaches a preset value, the controller 280 controls the moving device 290 to upwardly move the soot preform 220 along the vertical axis 210. A distance between T1 and T4 is preferably less than 1 mm and a difference between T1 and T4 is preferably less than 100° C.

In VAD according to an embodiment of the present invention (for depositing the soot in the soot preform 220 arranged on the vertical axis 210 using the first torch 230 and the second torch 240), the method for controlling deposition of the soot preform 220 includes detecting the temperature (T1) of the end of the soot preform 220 along the vertical axis 210 and the temperature (T4) of a point downwardly separated from the core 222, calculating a difference between T1 and T4, and moving the soot preform 220 along the vertical axis 210 such a way to reduce the difference between T1 and T4 to a preset temperature or less.

As described above, according to the present invention, the overall temperature distribution of the end of a soot preform and a temperature change in a lower portion of the soot preform according to soot deposition are detected using a thermometer to control upward movement of the soot preform. Thus, the present invention improves: (1) the quality of the soot preform, (2) the optical characteristics of an optical fiber acquired from the soot preform, and (3) the mass production rate and reliability of the soot preform.

While the present invention has been shown and described with reference to a preferred embodiment thereof, it will be understood by those skilled in the art that various changes in form and details may be made therein without departing from the spirit and scope of the invention.

What is claimed is:

1. A Vapor Axial Deposition (VAD) apparatus comprising:
a first torch used to grow a core, wherein soot is deposited at an end of a soot preform arranged on an axis;
a second torch used to grow a clad, wherein soot is deposited on a face of the core;
a thermometer to detect the temperature of the end of the soot preform along the axis and the temperature of an other/lower portion of the core;
a controller to calculate a difference between a temperature (T1) of the end of the soot preform and a temperature (T4) of a lower portion of the core and to control the movement of the soot preform; and
a moving device to move the soot preform along the axis.

2. The VAD apparatus of claim 1, wherein the axis is a vertical axis and the face of the core is circumferential.

3. The VAD apparatus of claim 1, wherein the movement of the soot preform is according to the difference in temperature of T1 and T4.

4. The VAD apparatus of claim 1, wherein the moving device is controlled by the controller.

5. The VAD apparatus of claim 1, wherein a distance between T1 and T4 is less than 1 mm.

6. The VAD apparatus of claim 1, wherein the difference between T1 and T4 is less than 100° C.

7. The VAD apparatus of claim 1, wherein the temperature T1 is adjusted by controlling a flow of fuel material provided in the first torch.

8. A Vapor Axial Deposition (VAD) method for depositing soot on a core in a soot preform arranged on an axis using a first torch and a second torch, the VAD method comprising the steps of:
(a) detecting a temperature (T1) of an end of the soot preform along the axis and a temperature (T4) of an other/lower portion of the core;
(b) calculating a difference between T1 and T4; and
(c) moving the soot preform along the axis to reduce the difference to a predetermined temperature or less.

9. The VAD method of claim 8, wherein in step (d), the difference between T1 and T4 is less than 100°C.
